(19) United States
(12) Patent Application Publication
(10) Pub. No.: US 2008/0317151 A1
(43) Pub. Date: Dec. 25, 2008

(54) Apparatus and method for forming subchannel in a communication system

(75) Inventors: Chi-Woo Lim, Suwon-si (KR); Tae-Young Kim, Seongnam-si (KR); Ho-Kyu Choi, Seongnam-si (KR); Jae-Weon Cho, Suwon-si (KR); Hyeon-Woo Lee, Suwon-si (KR); Dong-Seek Park, Yongin-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/214,281

(22) Filed: Jun. 18, 2008

(30) Foreign Application Priority Data
Jun. 19, 2007 (KR) 2007-60170

(51) Int. Cl. H04L 27/28

(52) U.S. Cl. 375/260

(57) ABSTRACT

A method for forming a subchannel in a communication system where a first communication system and a second communication system coexist. The method includes determining a first tile set by arranging first tiles remaining after forming at least one first subchannel for the first communication system among frequency resources, including a plurality of tiles, available for the first communication system; determining a second tile set by inserting second tiles which are independent of the frequency resources and are available for the second communication system into the determined first tile set at predetermined positions; forming at least one second subchannel for the second communication system by selecting a predetermined number of tiles from the second tile set; and performing communication using at least one of the first subchannel and the second subchannel.

### CROSS-REFERENCE TO RELATED APPLICATION(S) AND CLAIM OF PRIORITY

The present application claims the benefit under 35 U.S.C. §119(a) of a Korean Patent Application filed in the Korean Intellectual Property Office on Jun. 19, 2007 and assigned Serial No. 2007-60170, the disclosures of which are incorporated herein by reference.

### TECHNICAL FIELD OF THE INVENTION

The present invention relates generally to a communication system, and in particular, to an apparatus and method for forming subchannels in a communication system.

### BACKGROUND OF THE INVENTION

Currently, intensive research into communication systems is being conducted to provide users with services having a high data rate and various Qualities-of-Service (QoS) features. To this end, a study is being carried out to develop a new communication system that adds mobility and QoS to wireless Local Area Network (LAN) systems and wireless Metropolitan Area Network (MAN) systems and ensures a higher data rate.

In order to support broadband transmission networks in a wireless MAN system, communication systems employing Orthogonal Frequency Division Multiplexing (OFDM) and/or Orthogonal Frequency Division Multiple Access (OFDMA) have been developed, and the typical OFDM/OFDMA communication system includes an Institute of Electrical and Electronics Engineers (IEEE) 802.16 communication system. With reference to FIG. 1, a description will now be made of a tile structure of each subchannel based on partial usage of sub-channels (PUSC) used in the IEEE 802.16 communication system.

FIG. 1 is a diagram illustrating a tile structure in a general communication system.

Referring to FIG. 1, a tile 101 represents a PUSC-based tile, and includes 8 data tones and 4 pilot tones during 3 OFDM symbol intervals. A subchannel for the communication system includes, for example, 6 tiles, or 72 tones, and the 72 tones include 48 data tones and 24 pilot tones.

In this way, the tile 101 includes 4 pilot tones. As a result, ⅓ of the tones constituting the entire tile are pilot tones. The pilot tones are used herein as pilot signals used for correctly performing channel estimation.

As described above, the pilot tones may act as overhead during actual data transmission and restrict the amount of resources necessary for actual data transmission.

### SUMMARY OF THE INVENTION

To address the above-discussed deficiencies of the prior art, it is a primary aspect of the present invention to address at least the problems and/or disadvantages and to provide at least the advantages described below. Accordingly, an aspect of the present invention provides an apparatus and method for forming subchannels in a communication system.

Another aspect of the present invention provides a subchannel forming apparatus and method for reducing the overhead caused by transmission of pilot tones in a communication system.

Further another aspect of the present invention provides a subchannel forming apparatus and method with increased data throughput in a communication system.

According to one aspect of the present invention, there is provided a method for forming a subchannel in a communication system. The subchannel forming method includes, when a first communication system and a second communication system coexist in the communication system, determining a first tile set by arranging first tiles remaining after forming at least one first subchannel for the first communication system among frequency resources, including a plurality of tiles, available for the first communication system; determining a second tile set by inserting second tiles which are independent of the frequency resources and are available for the second communication system into the determined first tile set at predetermined positions; forming at least one second subchannel for the second communication system by selecting a predetermined number of tiles from the second tile set; and performing communication using at least one of the first subchannel and the second subchannel.

According to another aspect of the present invention, there is provided an apparatus for forming a subchannel in a communication system. The subchannel forming apparatus includes a first device for, when a first communication system and a second communication system coexist in the communication system, determining a first tile set by arranging first tiles remaining after forming at least one first subchannel for the first communication system among frequency resources, including a plurality of tiles, available for the first communication system, determining a second tile set by inserting second tiles which are independent of the frequency resources and are available for the second communication system into the determined first tile set at predetermined positions, and forming at least one second subchannel for the second communication system by selecting a predetermined number of tiles from the second tile set; and a second device for performing communication using at least one of the first subchannel and the second subchannel.

According to further another aspect of the present invention, there is provided a method for forming a subchannel in a communication system. The subchannel forming method includes forming at least one subchannel for the communication system among available frequency resources including a plurality of tiles; and performing communication using the subchannel. Preferably, the subchannel comprises multiple types of tiles, and the multiple types of tiles each comprise a different number of pilot subcarriers.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a tile structure in a general communication system;

FIGS. 2A and 2B are diagrams illustrating tile structures in a communication system according to an embodiment of the present invention;

FIG. 3 is a diagram illustrating PUSC subchannel forming in a communication system according to an embodiment of the present invention;

FIG. 4 is a diagram illustrating forming of E-PUSC subchannels in a communication system according to an embodiment of the present invention; and

FIG. 5 is a flowchart illustrating a method for forming subchannels in a communication system according to an embodiment of the present invention.

### DETAILED DESCRIPTION OF THE INVENTION

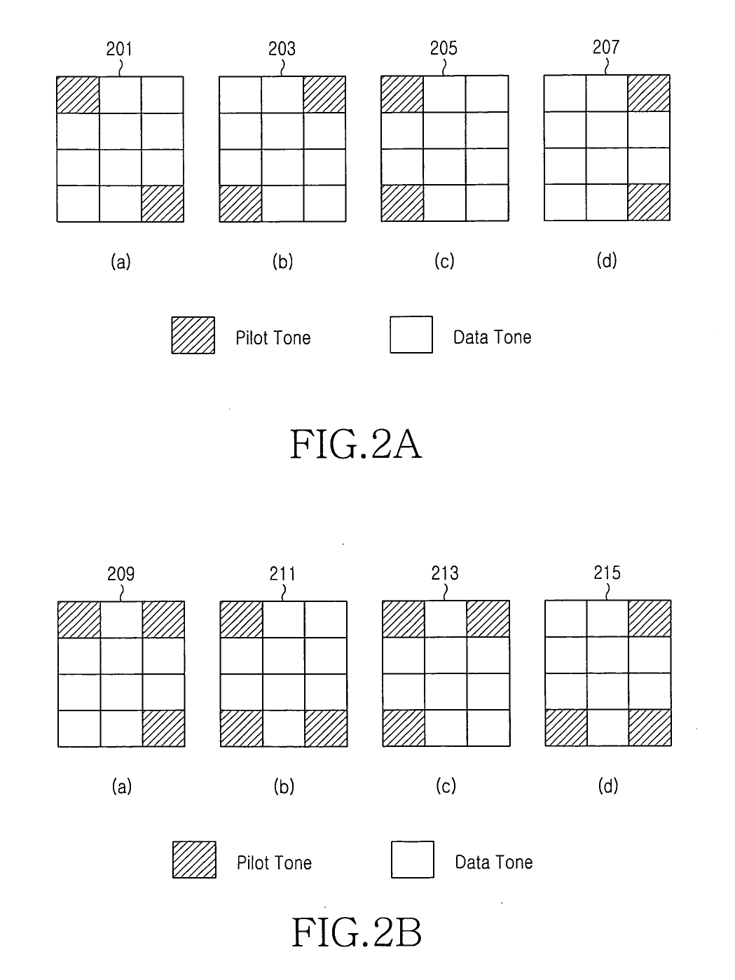

FIGS. 2A through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

A communication system, to which the present invention is applicable, uses Orthogonal Frequency Division Multiplexing (OFDM) and/or Orthogonal Frequency Division Multiple Access (OFDMA), and can be, for example, an Institute of Electrical and Electronics Engineers (IEEE) 802.16 communication system.

In this communication system, the subchannels described herein will be assumed to be uplink subchannels by way of example. In addition, the communication system is assumed to use Frequency Division Multiplexing (FDM), which divides a frequency band of the link shared by a base station and terminals and allocates the divided frequency bands to the terminals. The communication system as used herein refers to a communication system where heterogeneous communication systems coexist, and it is assumed that for example, an 802.16e communication system and an 802.16m communication system coexist therein.

In the communication system according to an embodiment of the present invention, a subchannel is formed of tiles each having a 4×3 structure in a frequency domain and a time domain. The tiles each include 12 tones during 4 subcarrier intervals and 3 OFDM symbol intervals. Before a description of the present invention is given, the subchannel scheme proposed by the present invention will be referred to as ‘Enhanced-Partial Usage of Sub-Channels (E-PUSC)’.

With reference to FIGS. 2A and 2B, a description will be made of the tile structure proposed by the present invention.

FIGS. 2A and 2B are diagrams illustrating tile structures in a communication system according to an embodiment of the present invention.

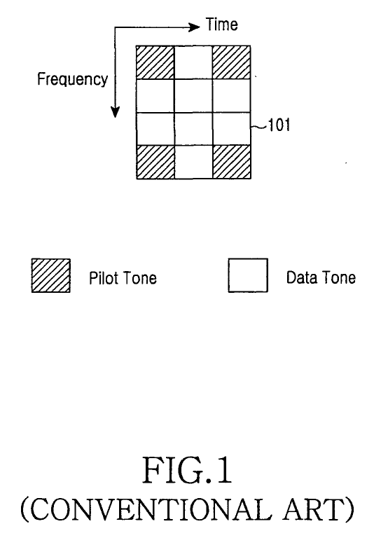

Before making reference to FIGS. 2A and 2B, it should be noted herein that the present invention proposes two types of tile structures: a first type and a second type. A description of the first-type tile structure will be given with reference to FIG. 2A, while a description of the second-type tile structure will be made with reference to FIG. 2B. For example, both the first-type tile structure and the second-type tile structure have the 4×3 PUSC tile structure shown in FIG. 1. Therefore, the first-type tile and the second-type tile each include 12 tones. However, the number of pilot tones included in the first-type tile and the second-type tile proposed by the present invention is less than the number of pilot tones included in the PUSC tile of FIG. 1.

Referring to FIG. 2A, a first-type tile 201 includes 10 data tones and 2 pilot tones. The tiles 201 to 207 defined in FIG. 2A show several possible examples each having 10 data tones and 2 pilot tones, and there can be other possible tiles having 2 pilot tones.

Referring to FIG. 2B, a second-type tile 209 includes 9 data tones and 3 pilot tones. The tiles 209 to 215 defined in FIG. 2B show several possible examples each having 9 data tones and 3 pilot tones, and there can be other possible tiles having 3 pilot tones.

The E-PUSC subchannel includes at least one of the two types of tiles shown in FIGS. 2A and 2B. For example, the E-PUSC based subchannel can include three first-type tiles 201 and two second-type tiles 209. As another example, the E-PUSC subchannel can include one PUSC tile 101 and three first-type tiles 201. A description of a subchannel forming scheme for the case where heterogeneous communication systems, e.g., an 802.16e communication system and an 802.16m communication system, coexist now will be provided.

The 802.16e communication system forms subchannels according to PUSC, while the 802.16m communication system forms subchannels according to E-PUSC. Subchannel forming for uplink data transmission will be described herein by way of example.

A terminal determines the number of PUSC subchannels used in the 802.16e communication system. The number of PUSC subchannels will be assumed herein to be N. Since the 802.16e communication system and the 802.16m communication system share the entire frequency band, the terminal determines the number of subchannels used in each communication system separately, depending on the determined number of PUSC subchannels.

Consideration will be given to the exemplary case where the terminal uses 1K (=1024)-point Fast Fourier Transform (FFT). When the terminal uses 1K-point FFT, the number of tiles existing in the entire frequency band becomes, for example, 210. The reason is as follows: Of the 1024 tones or subcarriers, the number of subcarriers actually used in the 802.16e communication system is 840, and the PUSC scheme uses a 4×3 tile structure. The number of tiles existing in the entire frequency band is defined as a value obtained by dividing the number of subcarriers, 840, by the number of subcarrier interval, 4, (840/4=210). For the terminal, since one PUSC subchannel is composed of 6 tiles, the maximum number of PUSC subchannels generated in the 802.16e communication system is 35.

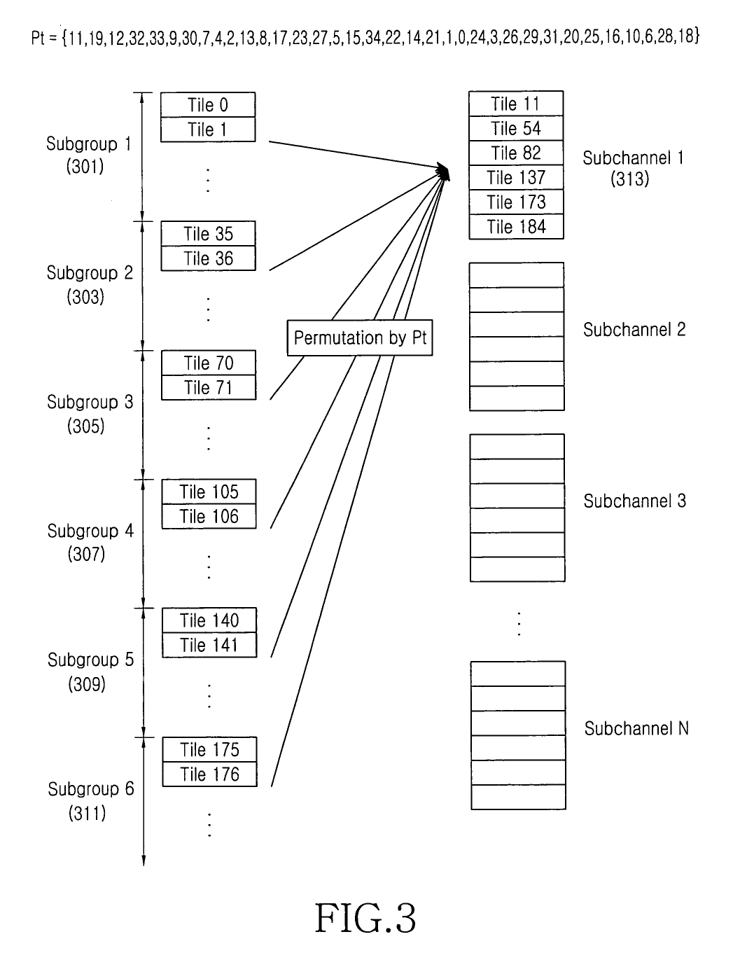

The tile is composed of a set of physically adjacent subcarriers, and a subchannel is formed by combining at least one tile. With reference to FIG. 3, a description will now be made regarding how to form PUSC subchannels according to an embodiment of the present invention.

FIG. 3 is a diagram illustrating PUSC subchannel forming in a communication system according to an embodiment of the present invention.

Referring to FIG. 3, a terminal divides tiles existing in the entire frequency band into a predetermined number (e.g., 6) of subgroups 301 to 311. The terminal selects one tile from each of the 6 subgroups 301 to 311 to form a PUSC subchannel 313. For example, the terminal selects one tile from each of the 6 subgroups using Equation 1:

Tile(s,n)=N_{subchannels}·n+(Pt[(s+n)mod N_{subchannels}]+UL_PermBase)mod N_{subchannels}, [Eqn. 1]

where Tile(s,n) denotes an index of an n^{th} tile in an s^{th} subchannel, and N_{subchannels} denotes the number of PUSC subchannels. The maximum number of PUSC subchannels is, for example, 35. UL_PermBase denotes an arbitrary value between 0 and 34.

Pt[x] denotes one element of a predetermined tile permutation and can be expressed as Equation 2 by way of example:

Pt={11, 19, 12, 32, 33, 9, 30, 7, 4, 2, 13, 8, 17, 23, 27, 5, 15, 34, 22, 14, 21, 1, 0, 24, 3, 26, 29, 31, 20, 25, 16, 10, 6, 28, 18} [Eqn. 2]

Referring to Equation 2, Pt[3]=12.

The terminal selects tiles constituting an uplink subchannel using Equation 1, and the tiles each are composed of 4 consecutive subcarriers on the basis of the frequency domain. Therefore, subcarriers allocated in the PUSC subchannel can be easily identified.

In the exemplary case of FIG. 3 where the terminal uses N PUSC subchannels, there are remaining tiles unused for forming of the PUSC subchannels, the number of the remaining tiles unused for PUSC subchannel forming is (35−N)*6, and these are used as E-PUSC subchannels based on the 802.16m communication system.

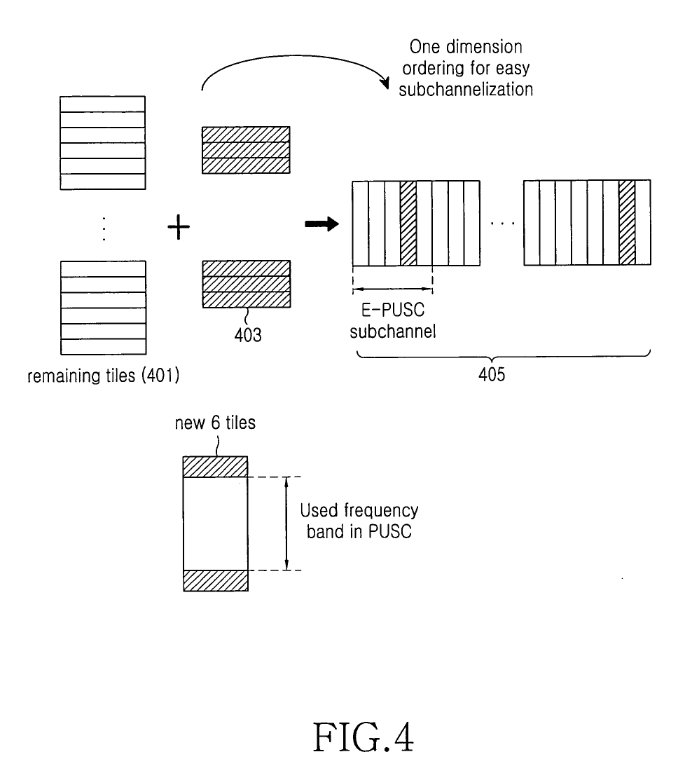

FIG. 4 is a diagram illustrating forming of E-PUSC subchannels in a communication system according to an embodiment of the present invention.

Referring to FIG. 4, there are shown tiles 401 remaining after PUSC subchannel forming is performed. The terminal arranges the remaining tiles 401 in regular order to form the E-PUSC subchannels.

Since the 802.16m communication system uses 864 subcarriers, which are greater in number than the 840 subcarriers used, for example, in the 802.16e communication system, when terminal generates E-PUSC subchannels based on the 802.16e communication system, 6 additional tiles are further formed. Since the increased number of subcarriers is 24 on the basis of the frequency domain and one tile is composed of 4 subcarriers in the frequency domain, 6 additional tiles are further formed.

The terminal inserts the additional tiles 403 into predetermined positions between the permuted tiles to form a tile set(s) 405 for an E-PUSC subchannel. Since the tile set 405 used to form the E-PUSC subchannel includes the tiles 401 remaining after forming the PUSC subchannels and the additional tiles 403, the number of tiles in tile sets 405 is determined according to the number of PUSC subchannels. For example, if the number of PUSC subchannels is N, the number of remaining tiles 401 is (35−N)*6, and when 6 additional tiles 403 are considered, the number of tiles in tile sets 405 is (35−N)*6+6.

The terminal selects 5 tiles from each of the tile sets 405 in sequence, to form E-PUSC subchannels. Through this process, it is possible to minimize a tile collision probability that the same tiles are repeatedly used for forming the E-PUSC subchannels and the PUSC subchannels.

In forming the tile sets 405, the terminal inserts each of the additional tiles 403 into a 4^{th} position of each subgroup so that a constant interval can be maintained between the additional tiles 403. There are other possible methods of inserting the additional tiles 403. For example, the terminal can determine a position of each of the additional tiles 403 inserted between the permuted tiles, using Equation 3:

New Tile Position(n)=(N_Subchannel−N)*n, [Eqn. 3]

where N_Subchannel denotes the number of PUSC subchannels, and the maximum number thereof is, for example, 35. In addition, N denotes the number of subchannels actually used in the PUSC subchannel in the case where different communication systems coexist. Further, n has a value between 1 and 6.

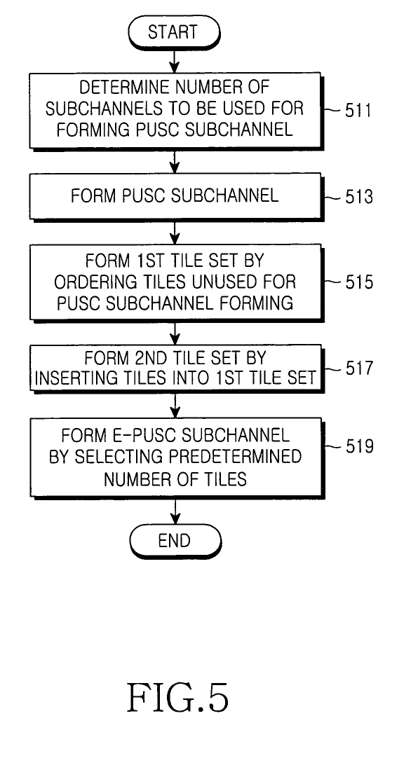

Equation 3 shows positions where the additional tiles are located in the permuted tiles. For example, the terminal disposes the additional tiles in (N_Subchannel−N) positions in the permuted tiles. With reference to FIG. 5, a description will now be made as to how the terminal forms the PUSC subchannels and the E-PUSC subchannels.

FIG. 5 is a flowchart illustrating a method for forming subchannels in a communication system according to an embodiment of the present invention.

Referring to FIG. 5, in step 511, a terminal determines the number of subchannels to be used for PUSC subchannel forming. Since PUSC subchannels and E-PUSC subchannels share the entire frequency band, once the number of PUSC subchannels is determined, the number of E-PUSC subchannels can be determined. A ratio of the PUSC subchannels to the E-PUSC subchannels can be predetermined. In step 513, the terminal forms the PUSC subchannels depending on the determined number of PUSC subchannels.

In step 515, the terminal arranges (or orders) the remaining tiles 401 unused for PUSC subchannel in regular order to form a first tile set. In step 517, the terminal inserts additional tiles 403 into the first tile set to generate a second tile set 405. In this case, the terminal inserts each of the additional tiles 403 into the first tile set at a predetermined position so as to maintain a constant interval between the additional tiles 403.

In step 519, the terminal sequentially selects a predetermined number of tiles from the second tile set to form E-PUSC subchannels. The terminal performs communication with a base station using at least one of the first subchannels (e.g., PUSC subchannels) and the second subchannels (e.g., E-PUSC subchannels). At least one of the formed E-PUSC subchannels can include different types of tiles, and the different types of tiles include the different number of pilot tones. For example, the remaining tiles 401 are formed as defined in FIG. 1 while the additional tiles 403 are formed as the first-type tiles 201-207 and/or the second-type tiles 209-215. As a result, even the E-PUSC subchannels are formed in different types.

As is apparent from the foregoing description, the present invention can form subchannels in which the overhead caused by pilot tones is reduced. In addition, the present invention can increase data throughput by reducing the overhead caused by pilot tones. Further, the present invention can properly insert newly added tiles into the tiles remaining after PUSC subchannel formation using a permutation scheme making it possible to generate subchannels and minimize a tile collision probability between the subchannels.

For example, the invention has described that the terminal generates the subchannels, but the base station is able to generate the subchannels and notify the terminal of the information related to the generated subchannels.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for forming a subchannel in a communication system, the method comprising:
when a first communication system and a second communication system coexist in the communication system, determining a first tile set by arranging first tiles remaining after forming at least one first subchannel for the first communication system among frequency resources, including a plurality of tiles, available for the first communication system;
determining a second tile set by inserting second tiles which are independent of the frequency resources and are available for the second communication system into the determined first tile set at predetermined positions;
forming at least one second subchannel for the second communication system by selecting a predetermined number of tiles from the second tile set; and
performing communication using at least one of the first subchannel and the second subchannel.

2. The method of claim 1, wherein the first subchannel comprises tiles each having 4 pilot subcarriers.

3. The method of claim 1, wherein the second subchannel comprises multiple types of tiles, and the multiple types of tiles each comprise a different number of pilot subcarriers.

4. The method of claim 3, wherein the second subchannel comprises at least one first-type tile having 2 pilot subcarriers and at least one second-type tile having 3 pilot subcarriers.

5. The method of claim 3, wherein the second subchannel comprises at least one first-type tile having 2 pilot subcarriers and at least one third-type tile having 4 pilot subcarriers.

6. The method of claim 1, wherein the predetermined positions are determined such that a constant interval is maintained between the second tiles.

7. The method of claim 1, wherein forming at least one second subchannel comprises:
forming the second subchannel by sequentially selecting a predetermined number of tiles.

8. An apparatus for forming a subchannel in a communication system, the apparatus comprising:
a first device for, when a first communication system and a second communication system coexist in the communication system, determining a first tile set by arranging first tiles remaining after forming at least one first subchannel for the first communication system among frequency resources, including a plurality of tiles, available for the first communication system, determining a second tile set by inserting second tiles which are independent of the frequency resources and are available for the second communication system into the determined first tile set at predetermined positions, and forming at least one second subchannel for the second communication system by selecting a predetermined number of tiles from the second tile set; and
a second device for performing communication using at least one of the first subchannel and the second subchannel.

9. The apparatus of claim 8, wherein the first subchannel comprises tiles each having 4 pilot subcarriers.

10. The apparatus of claim 8, wherein the second subchannel comprises multiple types of tiles, and the multiple types of tiles each comprise a different number of pilot subcarriers.

11. The apparatus of claim 10, wherein the second subchannel comprises at least one first-type tile having 2 pilot subcarriers and at least one second-type tile having 3 pilot subcarriers.

12. The apparatus of claim 10, wherein the second subchannel comprises at least one first-type tile having 2 pilot subcarriers and at least one third-type tile having 4 pilot subcarriers.

13. The apparatus of claim 8, wherein the predetermined positions are determined such that a constant interval is maintained between the second tiles.

14. The apparatus of claim 8, wherein the first device forms the second subchannel by sequentially selecting a predetermined number of tiles.

15. A method for forming a subchannel in a communication system, the method comprising:
forming at least one subchannel for the communication system among available frequency resources including a plurality of tiles; and
performing communication using the subchannel;
wherein the subchannel comprises multiple types of tiles, and the multiple types of tiles each comprise a different number of pilot subcarriers.

16. The method of claim 15, wherein the subchannel comprises at least one first-type tile having 2 pilot subcarriers and at least one second-type tile having 3 pilot subcarriers.

17. The method of claim 15, wherein the subchannel comprises at least one first-type tile having 2 pilot subcarriers and at least one third-type tile having 4 pilot subcarriers.
